(19) United States
(12) Patent Application Publication
(10) Pub. No.: US 2018/0320680 A1
(43) Pub. Date: Nov. 8, 2018

(54) Compressor Housing

(71) Applicant: MAN DIESEL & TURBO SE, Augsburg (DE)

(72) Inventors: Roger SUTER, Zurich (CH); Michael Betschart, Vitznau (CH)

(21) Appl. No.: 15/966,903

(22) Filed: Apr. 30, 2018

(30) Foreign Application Priority Data
May 2, 2017 (DE) 102017207366.7

(51) Int. Cl. F04B 39/12; F04B 27/10; F04D 29/40; F16L 19/04

(52) U.S. Cl. CPC F04B 39/121; F16L 19/04; F04D 29/40; F04B 27/1081

(57) ABSTRACT

A compressor housing, that includes a cylindrical housing basic body and at least one cover, which closes the housing basic body at an end of the same. The compressor housing for providing a stop for the respective cover has a threaded ring with an external thread, which via its external thread is screwed into the respective end of the housing basic body has an internal thread.

### BACKGROUND OF THE INVENTION

### 1. Field of the Invention

The invention relates to a compressor housing. The invention, furthermore, relates to a method for assembling or disassembling a threaded ring on a cylindrical housing basic body of the compressor housing.

### 2. Description of the Related Art

Compressor housings are used for example on compressors for industrial plants, such as air separation plants. Such compressors comprise a compressor housing and a rotor received or mounted in the compressor housing, which comprises multiple compressor stages. The compressor housing comprises a cylindrical housing basic body and on at least one end, preferentially on both opposite ends, a cover. Together, housing basic body and cover define an interior of the compressor housing in which a medium to be compressed is compressed via the rotor. The medium to be compressed is feedable to the compressor via an inflow of the compressor housing and dischargeable from the compressor housing via an outflow.

In the case of compressor housings known from practice, the connection of the or each cover with the cylindrical housing basic body are not embodied optimally. For this reason, the housing basic bodies of the compressor housing of compressors known from practice are typically relatively thick using a lot of material to avoid a failure of the housing basic body in the connection region of the respective cover. This brings with it heavy weight and high costs of compressor housings.

### SUMMARY OF THE INVENTION

One aspect of the present invention is based on creating a new type of compressor housing or a compressor housing with optimised connections. Furthermore, the invention is to provide a method for the assembly or disassembly of a threaded ring on a cylindrical housing basic body of the compressor housing.

According to one aspect of the invention, the compressor housing provides a stop for each respective cover that comprises at least one threaded ring with an external thread, which via its external thread is screwed into the respective end of the housing basic body that comprises an internal thread. Because of the fact that with the compressor housing has a threaded ring, which via its external thread is screwed into an internal thread at the respective end of the housing basic body, which is utilised for the assembly of the cover in the compressor housing, the housing basic body in particular can be embodied with a smaller wall thickness and accordingly lighter and more cost-effectively.

According to a further development of the invention, the threaded ring is rotation-locked relative to the housing basic body of the compressor body via a rotation lock.

According to a first version, the rotation lock comprises at least one locking element wherein the respective locking element interacts via a first screw with the housing basic body and via a second screw with the threaded ring in such a manner that the first screw extends into the housing basic body and the second screw into the threaded ring, wherein the second screw extends through the threaded ring and supports itself on the cover.

According to an alternative second version, the rotation lock comprises a locking ring or a locking segment ring, wherein the locking ring or the locking segment ring in sections projects into a radially inner groove in the threaded ring, and wherein first screws extend through a section of the locking ring or of the locking segment ring projecting out of the radially inner groove of the threaded ring and support themselves on the cover.

Both versions provide an advantageous rotation lock for the threaded ring on the compressor housing. The first version is particularly preferred since the same is a particularly simple design.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the subclaims and the following description. Exemplary embodiments of the invention are explained in more detail by way of the drawing without being restricted to this. It shows:

FIG. 1: is a cross section in an axial direction through a first compressor housing of a compressor in a region of an end of the compressor housing;

FIG. 2: is a cross section in the axial direction through a second compressor housing of a compressor in the region of an end of the compressor housing;

FIG. 3: is the compressor housing during an assembly or disassembly of the threaded ring;

FIG. 4: is the compressor housing during an assembly or disassembly of the threaded ring; and

FIG. 5: is the compressor housing during an assembly or disassembly of the threaded ring.

### DETAILED DESCRIPTION OF THE PRESENTLY PREFERRED EMBODIMENTS

The present invention relates to a compressor housing of a compressor, in particular of a compressor for industrial applications. Furthermore, the invention relates to a method for the assembly and disassembly of such a compressor housing.

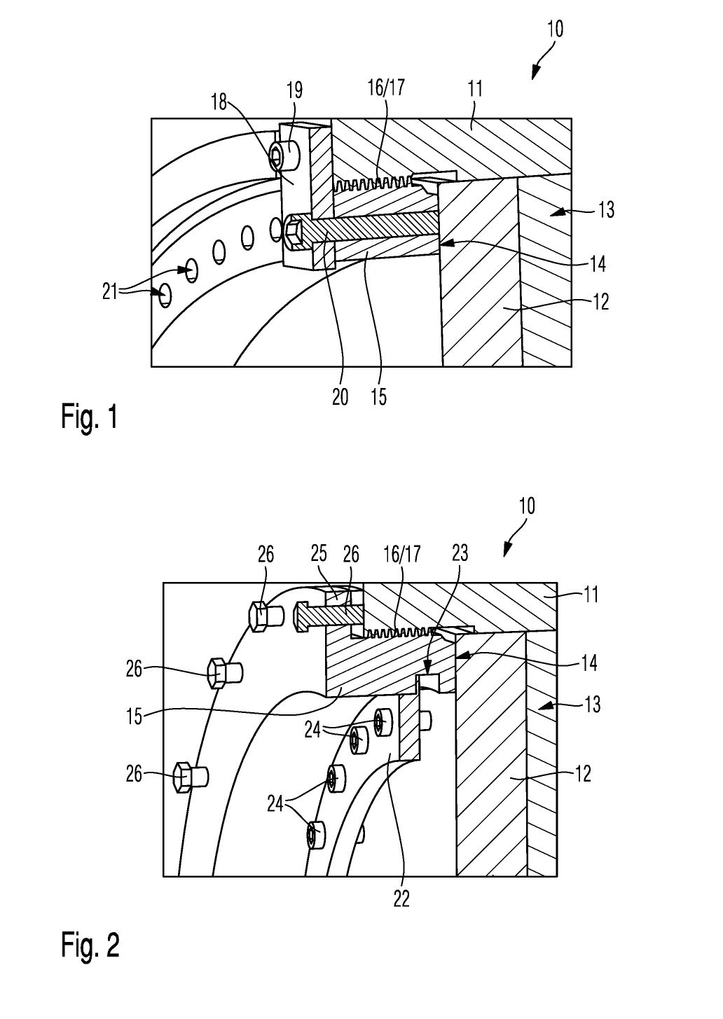

A compressor comprises a compressor housing 10 and a rotor received in the compressor housing 10, which typically provides multiple compressor stages. In FIG. 1, an extract from the compressor housing 10 without the rotor is shown, namely in a region of an end of a cylindrical housing basic body 11 into which a cover 12 is inserted at the shown end. Because of the pressure that is present in an interior 13 of the compressor housing 10 the cover 12 is pressed against a stop 14, which is provided by a threaded ring 15. The threaded ring 15 comprises an external thread 16 that interacts with an internal thread 17 formed at the end of the housing basic body 11 shown in FIG. 1 in such a manner that the threaded ring 15 via its external thread 16 can be screwed or is screwed into the internal thread 17 at the end of the cylindrical housing basic body 11 shown in FIG. 1. This allows a particularly simple provision of the stop 14 for the cover 12 with small wall thicknesses in the region of the cylindrical housing basic body 11. Axial forces originating from the cover 12 transmitted to the stop 14 and thus the threaded ring 15 can be optimally discharged into the housing basic body 11 via the thread pitches.

Preferentially, the threaded ring 15 has a greater hardness than the cylindrical housing basic body 11. Both housing basic body 11 and also threaded ring 15 preferentially consist of a steel while the alloy 42CrMo4 is particularly suitable as material for the threaded ring 15.

Any types of thread can be utilised for the external thread 16 of the threaded ring 15 and the internal thread 17 of the cylindrical housing basic body 11, preferably the threads 16, 17 are embodied in such a manner that the same provide a thread screw connection of the threaded ring 15 with the cylindrical housing basic body 11 that is not self-locking. For providing such a screw connection that is not self-locking, trapezoidal threads can be utilised the flank angle of which can lie in the order of magnitude of 30°. Threads which are not self-locking are preferred in order to be able to easily screw the threaded ring 15 into the housing basic body 11.

In the case of compressors for industrial applications the internal diameter of the internal thread 17 of the housing basic body 11 can be up to 3 m.

The screwing dimension of the threaded ring 15 into the respective end of the cylindrical housing basic body 11 defines how far the stop 14 provided by the threaded ring 15 projects into the interior of the compressor housing 10 and accordingly defines the relative position of the stop 14 for the cover 12.

Preferentially, the threaded ring 15 in its position screwed into the housing basic body 11 is rotation-locked on the housing basic body 11 of the compressor housing 10 with a rotation lock.

In the exemplary embodiment shown in FIG. 1, the rotation lock is provided by at least one locking element 18 that via a first screw 19 interacts with the housing basic body 11 and via a second screw 20 interacts with the threaded ring 15. Here, the first screw 19 extends through the locking element 18 and into the housing basic body 11. The second screw 20 likewise extends through the locking element 18 into the threaded ring 15, wherein the second screw 20 preferentially completely penetrates the threaded ring 15 and supports itself on the cover 12. Multiple such locking elements 18, which in each case interact with the first screw 19 and the second screw 20, can be distributed over the circumference in order to provide a rotation lock which can adequately absorb active moments. In FIG. 1, multiple recesses 21 are formed in the threaded ring 15 to provide, dependent on the position of the threaded ring 15 relative to the housing basic body 11 and relative to the locking element 19, a corresponding recess 21 for receiving the respective second screw 20 on the threaded ring 15.

FIG. 2 shows a further embodiment of a compressor housing 10 according to the invention, namely at an axial end of the compressor housing 10, wherein FIG. 2, like FIG. 1, shows the cylindrical housing basic body 11 with its internal thread 17, the cover 12 and the threaded ring 15 with its external thread 16.

The exemplary embodiment of FIG. 2 differs from the exemplary embodiment of FIG. 1 by the design of the rotation lock which utilises a frictional connection. Accordingly, a locking ring or a locking segment ring 22 is present in the exemplary embodiment of FIG. 2, wherein the locking segment ring 22 projects into a radially inner groove 23 of the threaded ring 15. First screws 24 extend through the locking segment ring 22, namely through a section of the same projecting out of the groove 23, and support themselves on the cover 12 and push the locking segment ring 22 away from the cover 12 against an axial boundary wall of the groove 23.

On the threaded ring 15, a protrusion 25 radially extending to the outside is formed on a section projecting out of the cylindrical housing basic body 11, through which protrusion 25 second screws 26 extend. The second screws 26 support themselves on the housing basic body 11 and push the threaded ring 15 away from the housing basic body 11.

With both exemplary embodiments, a stop 14 can be provided for the cover 12 via the threaded ring 15. The position of the cover 12 during operation is thus uniquely defined. A rotation lock preferentially locks the threaded ring 15 against an intentional rotation relative to the housing basic body 11. Although in FIGS. 1 and 2 merely one end of the housing basic body 11 is shown, the solution according to one aspect of the invention can be employed on both ends of the cylindrical housing basic body 11.

As already explained, an outer diameter of the threaded ring 15 or an inner diameter of the cylindrical housing basic body 11 is up to 3 m. For this reason it is required to precisely align and guide the threaded ring 15 in a defined manner during the assembly and disassembly of the same on the cylindrical housing basic body 11 in order to avoid a jamming of the same during the assembly and disassembly.

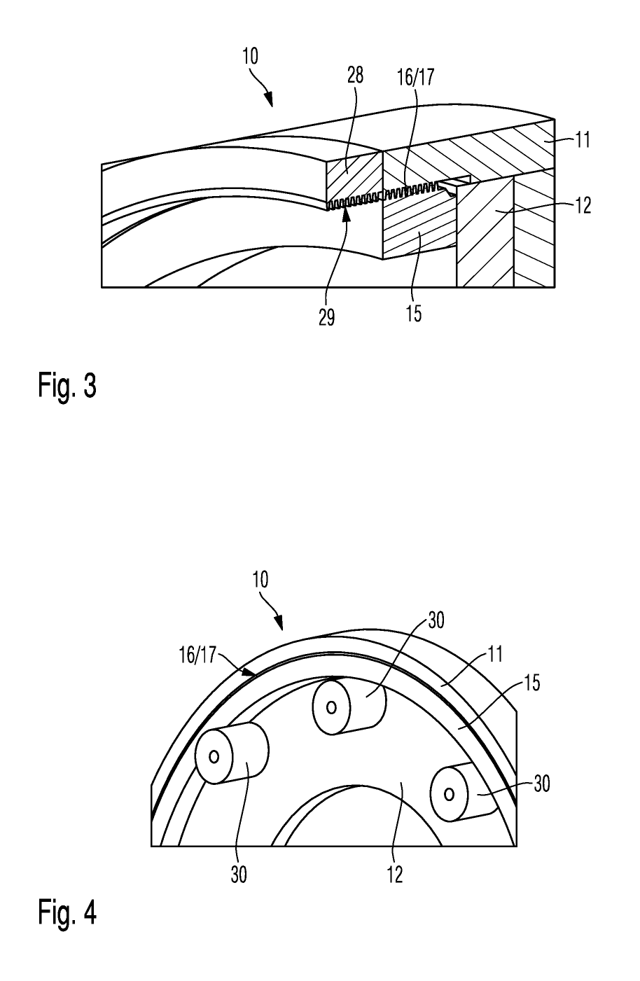

FIG. 3 shows details of a first method for the assembly and disassembly of the threaded ring 15 on the cylindrical housing body 11 of the compressor housing 10 of a compressor. Accordingly, for the assembly and disassembly of the threaded ring 15, in the exemplary embodiment shown in FIG. 3, an assembly ring 28, which axially extends the housing basic body 11 at the respective end of the same and comprises an internal thread 29 extending the internal thread 17 of the housing basic body 11 is fastened at the end of the housing basic body 11, on which the threaded ring 15 is assembled or disassembled.

For the assembly of the threaded ring 15, the assembly ring 28, which receives the threaded ring 15, is assembled on the housing basic body 11 such that the internal threads 17, 29 from the housing basic body 11 and assembly ring 28 complete one another so that the threaded ring 15 starting out from the assembly ring 29 can then be transferred or screwed into the end of the housing basic body 11 in the position shown in FIG. 3. If starting out from FIG. 3 the threaded ring 15 is to be disassembled from the housing basic body 11, the threaded ring 15 is screwed out of the housing basic body 11 and into the assembly ring 28 in order to be subsequently removed from the housing basic body 11 together with the assembly ring 28.

Here, the assembly ring 28 provides a tool for carrying out the method according to the invention, wherein the invention furthermore relates to the assembly ring 28 for carrying out the method described making reference to FIG. 3. The assembly ring 28 can be assembled to an end of the housing basic body 11 and comprises an internal thread 29, which extends or completes the internal thread 17 of the housing basic body 11. The internal thread 29 of the assembly ring 28 is or will be produced together with the internal thread 17 of the housing basic body 11.

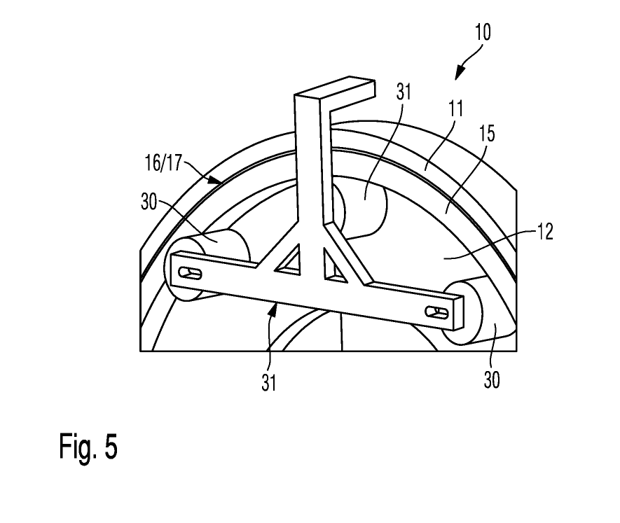

FIGS. 4 and 5 show versions for the assembly or disassembly of the threaded ring 15 on or from the housing basic body 11 to the compressor housing 10. In FIG. 4, multiple roller-like assembly bodies 30 are assembled on the cover 12. For assembling the threaded ring 15 on the housing basic body 11, the threaded ring 15 is positioned on the roller-like assembly bodies 30, which precisely align the threaded ring 15 to be subsequently screwed into the compressor housing 10, namely into the housing basic body 11 of the same. During the disassembly, the threaded ring 15 is screwed out of the housing basic body 11 and can in the process be put down on the roller-like assembly bodies 13 or held by the same in order to subsequently remove the threaded ring 15 following the unscrewing from the housing basic body 11.

While in FIG. 4 the roller-like assembly bodies 30 are fastened on the cover 12, FIG. 5 shows a version in which the roller-like assembly bodies 30 are assembled on a separate support structure 31, which for the assembly or disassembly of the threaded ring 15 is then aligned relative to the cylindrical housing basic body 11.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A compressor housing, comprising:
a cylindrical housing basic body having an internal thread at least at one end;
at least one cover that closes a respective end of the housing basic body; and
a stop for the at least one cover comprising:
at least one threaded ring with an external thread, the external thread is screwed into the at least one end of the housing basic body via the internal thread.

2. The compressor housing according to claim 1, further comprising a rotation lock via which the threaded ring is rotation-locked relative to the housing basic body.

3. The compressor housing according to claim 2,
wherein the rotation lock comprises at least one locking element,
wherein each respective locking element interacts with the housing basic body via a first screw and with the threaded ring via a second screw.

4. The compressor housing according to claim 3, wherein the first screw extends into the housing basic body and the second screw extends into the threaded ring.

5. The compressor housing according to claim 4, wherein the second screw extends through the threaded ring and supports itself on the cover.

6. The compressor housing according to claim 2,
wherein the rotation lock comprises one of:
a locking ring or
a locking segment ring,
wherein the locking ring or the locking segment ring in sections projects into a radially inner groove in the threaded ring, and
wherein first screws extend through a respective section of the locking ring or the locking segment ring projecting out of the radially inner groove of the threaded ring and support themselves on the cover.

7. The compressor housing according to claim 6, wherein the threaded ring comprises a radially outer protrusion, wherein second screws extend through the radially outer protrusion of the threaded ring and support themselves on the housing basic body.

8. A method for the assembling or disassembling a threaded ring on a cylindrical housing basic body of a compressor housing having a cylindrical housing basic body having an internal thread at least at one end, at least one cover that closes a respective end of the housing basic body, and a stop for the at least one cover having the threaded ring with an external thread, the external thread is configured to screw into the at least one end of the housing basic body via the internal thread, comprising:
fastening an assembly ring at the end of the housing basic body, at which the threaded ring is assembled or disassembled, that axially extends the housing basic body at the end and comprises an internal thread extending the internal thread of the housing basic body
wherein for the assembly of the threaded ring the assembly ring receives the threaded ring and the threaded ring is screwed from the assembly ring into the end of the housing basic body, and
wherein for the disassembly of the threaded ring the housing basic body receives the threaded ring and the threaded ring is screwed from the housing basic body into the assembly ring.

9. An assembly ring configured to carry out the method according to claim 8, wherein the assembly ring comprises an internal thread that extends the internal thread of the housing basic body.

10. The assembly ring according to claim 9, wherein the internal thread of is produced together with the internal thread of the housing basic body.

11. A method for the assembly or disassembly of a threaded ring on a cylindrical housing basic body of a compressor housing having a cylindrical housing basic body having an internal thread at least at one end, at least one cover that closes a respective end of the housing basic body, and a stop for the at least one cover having the threaded ring with an external thread, the external thread is configured to screw into the at least one end of the housing basic body via the internal thread, comprising:
assembling roller-like assembly bodies on the cover or a separate support structure;
wherein for the assembly of the threaded ring:
positioning the threaded ring on the roller-like assembly bodies; and
subsequently screwing the threaded ring into the end of the housing basic body, and
wherein for the disassembly of the threaded ring:
the threaded ring is screwed out of the housing basic body and in the process positioned on the roller-like assembly bodies.
